(19) United States
(12) Patent Application Publication
(10) Pub. No.: US 2008/0150839 A1
(43) Pub. Date: Jun. 26, 2008

(54) CONTROLLING LIGHT EMISSION IN DISPLAY DEVICE

(76) Inventor: Kazuyoshi Kawabe, Yokohama (JP)

Correspondence Address: Frank Pincelli, Patent Legal Staff;Eastman Kodak Company, 343 State Street, Rochester, NY, 14650-2201, US

(21) Appl. No.: 11/954,067

(22) Filed: Dec. 11, 2007

(30) Foreign Application Priority Data
Dec. 20, 2006 (JP) 2006-343194
Jul. 25, 2007 (JP) 2007-193731

(51) Int. Cl. G09G 3/28

(52) U.S. Cl. 345/63

(57) ABSTRACT

A display device including a self-emissive type display element in each pixel, the display device further including a detection circuit for detecting light emission data which indicates an amount of light emission while sequentially illuminating only a particular one of pixels according to a particular luminance data; and a supply controller for determining an amount of light emission for an equalization process for each pixel according to the detection result by the detection circuit and for supplying light emission data to each pixel for enabling illumination at the determined amount of light emission.

### CROSS-REFERENCE TO RELATED APPLICATION

This application claims priority of Japanese Patent Application No. 2006-343194 filed Dec. 20, 2006 and Japanese Patent Application No. 2007-193731 filed Jul. 25, 2007, which are incorporated herein by reference in their entirety.

### FIELD OF THE INVENTION

The present invention relates to a display device which includes a self-emissive element as a display element.

### BACKGROUND OF THE INVENTION

Liquid crystal display (LCD) devices have been widely used as a flat panel display. The LCD, however, only controls an amount of light transmitted through each pixel, and requires a back light or the like. On the other hand, an organic EL display is a self-emissive type which can control a light emission amount of each pixel, enabling a high contrast and a wide viewing angle. Therefore, the organic EL display has attracted attention as a next-generation display.

However, in the self-emissive type display, an amount of light emission of each pixel differs depending on image content. Therefore, deterioration degrees of organic EL elements are uneven among pixels, easily causing so-called burn-in, with which previous images not relating to a current image remain visible.

A method for reducing burn-in is disclosed in Japanese Patent Laid-Open Publication No. 2003-228329, in which deterioration of organic EL elements is estimated from an image data and equalized based on the estimation while a display is not in use.

However, in the above-mentioned related art, deterioration of an organic EL element is estimated from data of an image, and thus deterioration due to usage environment such as temperature are not considered. Therefore, the estimation does not always match with the actual deterioration, so the deterioration cannot be equalized effectively. Such equalization may cause future burn-in.

### SUMMARY OF THE INVENTION

An aspect of the present invention is a display device which includes a self-emissive type display element in each pixel. The display device further includes a detection circuit for detecting a light emission data which indicates an amount of light emission while sequentially illuminating only a particular one of pixels according to a particular luminance data, and a supply controller for determining an amount of light emission for an equalization process for each pixel according to the detection result by the detection circuit and for supplying light emission data into each pixel for enabling illumination at the determined amount of light emission.

Additionally, the detection circuit preferably detects, as the light emission data of the particular pixel, an amount of current in the display device while the particular pixel is emitting light.

Furthermore, the supply controller preferably performs the equalization process by determining luminance data for equalization based on the light emission data detected by the detection circuit, and by supplying, into each pixel, the luminance data for equalization instead of normal luminance data for each pixel.

When displaying each pixel according to image data supplied from outside, it is preferable to perform analog driving to supply luminance data according to the image data of each pixel into the pixel and to control gradation of light emission luminance of each pixel. When detecting the light emission data by means of the detection circuit, it is preferable to detect an amount of light emission while supplying constant luminance data.

When displaying each pixel according to the image data supplied from outside, it is also preferable to perform digital driving to supply data for controlling a light emission period according to the image data of each pixel into the pixel and to control gradation of light emission luminance of each pixel. When detecting the light emission data by means of the detection circuit, it is preferable to detect the amount of light emission at the time of illumination by digital driving.

Additionally, the self-emissive type display element is preferably an organic EL element.

Furthermore, when detecting light emission data by means of a detection circuit, it is preferable to detect the light emission data by measuring a current while applying a constant voltage to the organic EL element.

Further, the light emission data indicating an amount of light emission is preferably one bit data which is obtained by comparing with a predetermined reference value.

Further, the detection circuit preferably detects an amount of analog current in the display device in which a particular pixel is emitting light and performs analog to digital (A/D) conversion on the detected value in order to create digital light emission data of the pixel.

Further, the detection circuit preferably obtains digital light emission data of multiple bits by sequentially comparing the detected amount of analog current with a variable reference value.

According to an aspect of the present invention, deterioration statuses of respective pixels can be equalized by an equalization process, and thus the occurrence of burn-in can be effectively suppressed.

### BRIEF DESCRIPTION OF THE DRAWINGS

FIG. 1 is an overall configuration diagram of a display device of an embodiment of the present invention;

FIG. 2 is an overall configuration diagram of an organic EL panel of an active matrix type;

FIG. 3A is a diagram showing deterioration characteristics of an organic EL element (changes over time of starting voltage and luminance);

FIG. 3B is a diagram showing deterioration characteristics (a relationship between a voltage and a current) of an organic EL element;

FIG. 4 is a diagram showing a configuration of supply controller 20 of reference value comparison type;

FIG. 5 is a diagram showing a configuration for A/D conversion; and

FIG. 6 is a diagram showing a configuration of switched capacitor type comparator.

### DETAILED DESCRIPTION OF THE PREFERRED EMBODIMENTS

A preferred embodiment of the present invention is described below in detail with reference to the drawings.

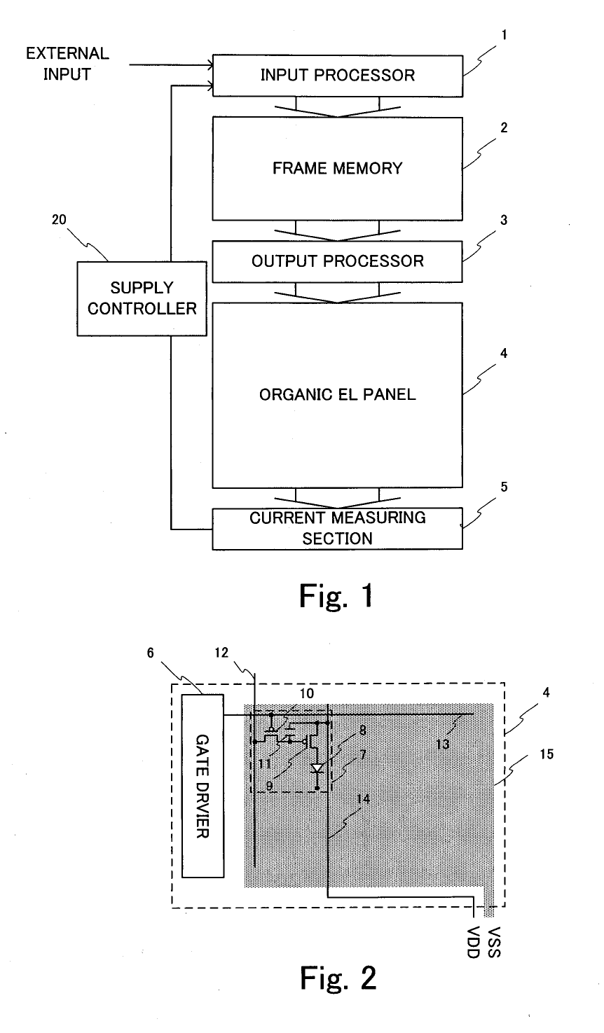

FIG. 1 shows an overall configuration of a display device related to an embodiment of the present invention. Input data which is input from an external input to an input processor 1 is image data which includes, in the case of full-color display, red (R), green (G), and blue (B), or these three colors plus white (W), and is transferred in units of one or a few pixels, as well as a clock signal or timing signal used for transmission of the image data. The image data in the input data is accumulated in the input processor 1 as the image data for one line, and stored in a frame memory 2 in units of one line. The image data for one screen stored in the frame memory 2 is read out in units of one line and output to an organic EL panel 4 by an output processor 3 line by line. The organic EL panel 4 reflects the supplied image data to a display. Note that descriptions have been omitted regarding the timing signal used for storing the image data into the frame memory 2, and the timing signal for reading out and outputting the image data into the organic EL panel 4.

Accordingly, in a structure with the frame memory 2 provided between the input processor 1 and the output processor 3, once image data is stored in the frame memory 2, the image data can be supplied from the frame memory 2 into the organic EL panel without the image data input from outside, and thus the image data does not need to be input constantly from outside. Therefore, consumption power required for transmitting data from outside can be reduced, and thus this structure is widely used for a device such as an LCD (Liquid Crystal Display) mounted on a portable terminal which requires a reduced power consumption. In such a case, the input processor 1, frame memory 2, and output processor 3 are often implemented as a driver IC.

Note that a current flowing through the organic EL panel 4 is measured by a current measuring section 5, and a supply controller 20 supplies, to the input processor 1, luminance data for an equalization process according to the measurement result from the current measuring section 5. This is described later.

FIG. 2 shows an internal structure of the organic EL panel 4. For the organic EL panel, an active type and a passive type are available. An example of the active type is shown in FIG. 2. The organic EL panel 4 includes pixels 7 disposed in a matrix pattern, a data line 12 as well as a power line 14 wired in a column direction of each pixel, and a gate line 13 in a row direction. A data signal which is processed by the output processor 3 is output to the data line 12. A selection signal from a gate driver 6 is output to the gate line 13. When the organic EL panel 4 is formed with a high-mobility transistor such as a low-temperature polysilicon, the gate driver 6 is formed on the same glass substrate by using it. It is also possible that the gate driver 6 is provided as a separate IC (Integrated Circuit) and connected to the organic EL panel 4.

All of the power lines 14 wired in the column direction are commonly have a VDD potential applied to their end sections. Cathode electrodes 15 of organic EL elements 8 are shared among all the pixels with a VSS potential applied.

The pixel 7 is formed such that an anode of the organic EL element 8 is connected to a drain terminal of a drive transistor 9, a source terminal of the drive transistor 9 is connected to the power line 14, and a gate terminal thereof is connected to one end of a storage capacitor 11 and to a source terminal of a gate transistor 10, while the other end of the storage capacitor 11 is connected to the power line 14. Additionally, a gate terminal of the gate transistor 10 is connected to the gate line 13, while a drain terminal thereof is connected to the data line 12.

When the gate line 13 is selected by the gate driver 6 (a low level is applied), the gate transistor 10 is turned on, and then a data signal supplied to the data line 12 from the output processor 3 is written into the storage capacitor 11. When the gate line 13 is unselected (a high level is applied), the data signal written in the storage capacitor 11 is retained thereafter, and the emitting state of the organic EL element 8 is maintained during the period.

With the structure of the pixel 7, when an appropriate analog voltage is applied to the gate terminal of the drive transistor 9, a constant current according to the analog voltage flows through the organic EL element 8, enabling analog drive with a constant current. When a sufficiently low voltage is supplied to turn on the drive transistor 9, a constant voltage (VDD-VSS) is applied to the organic EL element 8. Thus, by controlling the time period during which the constant voltage is applied, it is also possible to use digital driving with a constant voltage.

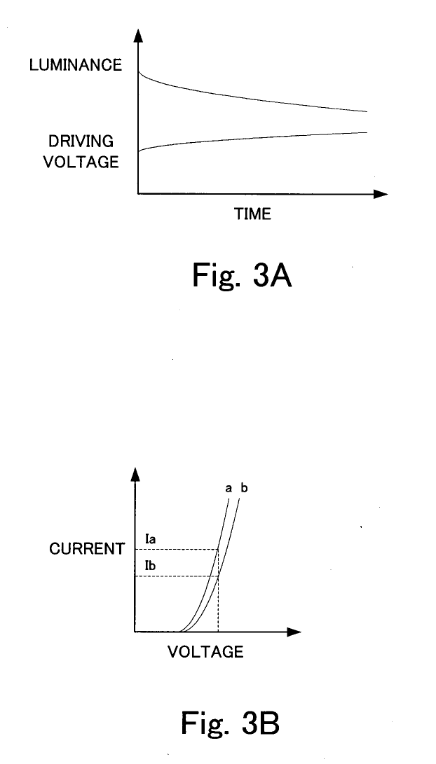

In order to display an externally input image, either one of the analog driving with a constant current or the digital driving with a constant voltage can be used as described above. However, in order to measure a deterioration rate of the organic EL element 8, it is more convenient to apply the constant voltage. The reason for this is described below with reference to FIG. 3.

FIG. 3A shows deterioration over time of luminance and driving voltage characteristics when the organic EL element is driven with a constant current. FIG. 3B shows a change in a voltage-current characteristic of the organic EL element. In a general organic EL element, as shown in FIG. 3A, the luminance decreases as time elapses, while a driving voltage which is required to cause the same current increases as time elapses. This indicates that the longer the time that the constant current flows, the less the luminance is and the more the driving voltage is required to obtain the same luminance. Therefore, acquisition of increased amount of driving voltage enables estimation of the deterioration rate of the luminance.

As illustrated in FIG. 3B, the current-voltage characteristics of the organic EL elements a and b which have been deteriorated by the flow of different constant currents show different currents Ia and Ib generated by applying a constant voltage. Thus, from the difference, the deterioration of the luminance can be estimated. That is, the deterioration rate can be estimated by measuring the current while applying a VDD-VSS voltage to the organic EL element 8 by applying, to the gate terminal of the drive transistor 9, a voltage which turns on the drive transistor 9.

For example, a current is measured by the current measuring section 5 at a time when, in one arbitrary pixel alone, the organic EL element 8 is illuminated with a constant voltage applied by turning on the drive transistor 9 after light emission of the whole screen is stopped at any time while no image is displayed based on an external input. The current measurement by the current measuring section 5 can be achieved by measuring the current flowing through VSS which is supplied into the cathode electrode 15. For example, an amount of current can be detected by disposing a current detecting resistor between the cathode electrode 15 and the power supply VSS and measuring a voltage drop across the current detecting resistor.

Since, in this case, only one pixel is emitting light, the measured current reflects the deterioration of the organic EL element of that pixel. The measured current data is transmitted to the supply controller 20. The supply controller 20 converts the measured current data into digital data and also transmits the measured current data to the input processor 1 while no image data is input from outside. It is preferable that the supply controller 20 displays “Perform a luminance compensation process?” or the like on a screen at the time of power off, and when an input of “Yes” is received, performs a luminance equalization process by supplying the current data to the input processor 1. It is also preferable to perform the luminance equalization process after a predetermined time has elapsed, automatically, or after a query at a time when no display is performed, or to perform the luminance equalization process automatically or after a query when a difference of deteriorations among respective pixels has exceeded a certain value.

The input processor 1 retrieves the transmitted measured data sequentially, accumulates the data for one line, and stores the data into the frame memory 2 in units of one line. By performing the similar measurement per pixel for all of the respective pixels, the current measurement data for all of the pixels are stored in the frame memory 2.

The measurement data stored in the frame memory 2 are read out in units of one line, transmitted to the output processor 3, and then output to the data lines 12 of the organic EL panel 4. When the measurement data can be assumed to be large when a current flowing through the organic EL element 8 is large, then an output data can be assumed similarly. Therefore, the organic EL panel 4 is driven to supply a larger current into a pixel with a large current flowing through the organic EL element 8, which indicates that the deterioration of the pixel is small, while the organic EL panel 4 is driven to supply a small current into a pixel with a small current flowing through the organic EL element 8, which indicates that the deterioration of the pixel is large. Accordingly, large deterioration is caused for a pixel with small deterioration, while small deterioration is caused for a pixel with a large deterioration. Therefore, the luminance deteriorations of the respective pixels are equalized.

After the luminance equalization display is performed for some period of time, the current is measured again by applying a constant voltage to the organic EL element 8 using the above described method, and the measured data is written into the frame memory 2 to update the luminance equalization display. In due course, there comes a point when no more differences occur in the measurement data, and then the luminance equalization display is finished.

By extracting a maximum value, minimum value, and average value of the measurement data at the time of the current measurement of the organic EL element 8, a range of deterioration unevenness can be monitored all the time. For example, the luminance equalization display can be controlled to stop when the difference between the maximum value and the minimum value becomes within a certain range. Accordingly, an excessive equalization display can be prevented. Furthermore, in the equalization display, unnecessary deterioration can be eliminated by setting the current to zero for a pixel with the maximum or large degree of deterioration.

Note that as a driving method performed in a period of the luminance equalization display, either one of analog driving with a constant current or digital driving with a constant voltage can be applied. Especially, when the digital driving with the constant voltage is used, the luminance can be equalized passively without performing the luminance equalization display actively according to the deterioration degree using the frame memory 2, because, by applying a constant voltage, a larger current flows in a pixel with a small deterioration, while a smaller current flows in a pixel with a large deterioration. Referring to FIGS. 3A and 3B, a current generated when a voltage is applied is larger for the organic EL element a with a small deterioration than for an organic EL element b with a large deterioration. Thus, the deterioration of the element a can be assumed to be accelerated more, automatically leading to a desired luminance equalization.

Whichever driving is employed, it is preferable to perform the luminance equalization display in such a manner that a large current does not flow in a pixel with a large deterioration, because the deterioration will be accelerated undesirably if a large current flows to a pixel with a large deterioration in a process of the luminance equalization. By performing equalization in this way, excessive power consumption is also effectively reduced.

When image data is input from outside during the luminance equalization display, the luminance equalization display is interrupted, and the display switches to display the external image. When no image is input from outside, the luminance equalization display resumes.

FIG. 1 shows the input processor 1, the frame memory 2, the output processor 3, and the current measuring section 5, all of which can be built-in on the same driver IC, or the frame memory 2 and the current measuring section 5 can be provided on a separate IC.

Also when the drive transistor 9 and the gate transistor 10 are formed of amorphous silicon, the luminance deterioration can be equalized using a similar method. When amorphous silicon is used for the drive transistor 9 and a larger gate voltage is applied to a gate terminal of the drive transistor 9 for a long time, a threshold voltage increase is accelerated and a current flowing through the organic EL element 8 is reduced, resulting in burn-in. In such a case, based on the current measurement data of each pixel stored in the frame memory, the threshold voltage increase can be equalized by applying, during the luminance equalization display period, a small gate voltage to the drive transistor of a pixel with a large current reduction, while applying a large gate voltage to the drive transistor of a pixel with a small current reduction.

The luminance equalization display is finished when the maximum value, the minimum value, the average value, or the like of the measurement data of all the pixels measured in repeated current measurements satisfy predetermined conditions.

Also in such a case, the luminance equalization display is preferably performed to apply a smaller gate voltage to the drive transistor of a pixel with a larger degree of deterioration, that is, a pixel indicating a larger increase in the threshold voltage.

In the above description, an amount of current is detected while illuminating only one pixel. However, it is also possible to detect an amount of light emission by using light receiving elements. The equalization process can also be achieved by detecting the amount of current while illuminating a plurality of pixels in units of one block, and in only a block having a large difference in the amount of current comparing with the average current amount, illuminating the respective pixels one by one.

### Pixel by Pixel Equalization Process of Reference Value Comparison Type

With a threshold value or a reference current value provided for a measured current, one bit data may be stored in the frame memory 2 so as to be reflected during the equalization period by illuminating a pixel when a current value measured by illuminating the pixel at a certain point is higher than the reference value, while not illuminating the pixel when the current value is smaller than the reference value. For example, with a reference current set to Ib, when a measured current Ia of pixel a is larger than the reference current Ib, the pixel a is controlled to be illuminated during the equalization. Similarly, when a measured current Ic of pixel c (not shown) is slightly higher than the reference current Ib, the pixel c is also illuminated. However, the measured value Ic of pixel c reaches to the reference current Ib comparatively earlier by one bit equalization process. Thus, the measured current Ic of pixel c reaches to the reference current Ib by the next measurement, so the pixel c is not illuminated at the next equalization. By repeating such process, the number of pixels to be illuminated with the measured current higher than the reference current is gradually decreased. In due course, no pixel is illuminated and the equalization is automatically stopped.

While updating one bit data in the frame memory 2 in accordance with current measured in each period that is obtained by dividing the equalization process period, the equalization process according to deterioration degree of each pixel can be performed.

During the equalization process period, all of the organic EL elements of illuminating pixels are driven by the same constant current or constant voltage. Overly bright illumination may undesirably cause a very noticeable illumination and high power consumption. Therefore, it is preferable to turn off all of the pixels after a predetermined period to avoid constantly flowing current and perform a duty control in which “on” period is set with an appropriate duty ratio. On this occasion, illumination appears to be intermitting when the duty cycle is long while illumination appears to be halftone when the duty cycle is short, enabling a more inconspicuous equalization.

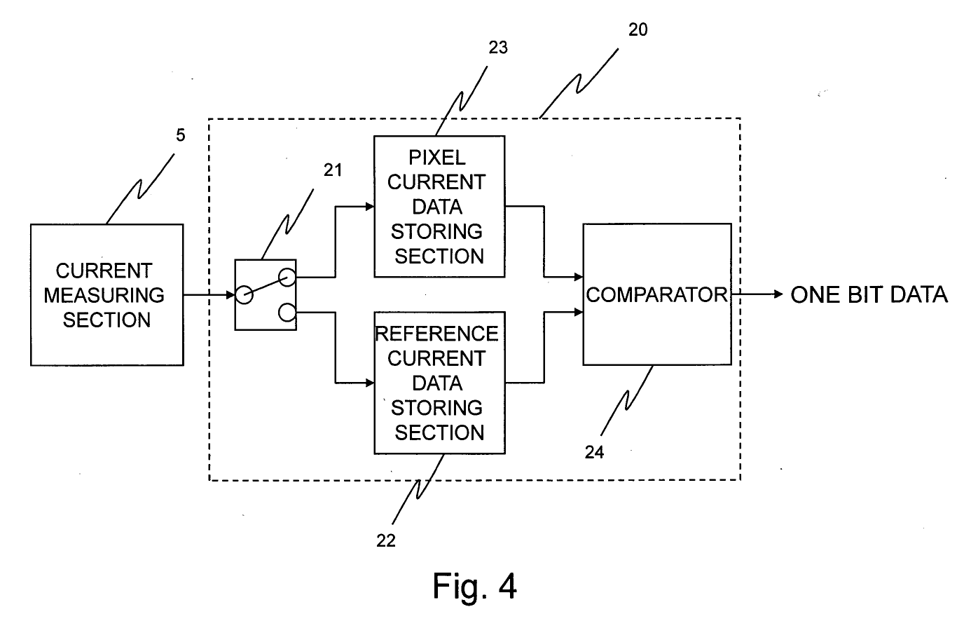

Such a one bit equalization process can be realized by introducing a system such as shown in FIG. 4 to the supply controller 20 shown in FIG. 1. First, in order to determine the reference current value, the current value is calculated at the current measuring section 5 while one arbitrary pixel in a screen being illuminated. The measured current data is stored by a switch 21 in a reference current data storing section 22 as the reference current data. It should be noted that, although a current is measured by selectively illuminating one arbitrary pixel in a screen in this case, the reference current value may be an average of multiple pixels. Alternatively, the reference current value may be determined, using a reference pixel provided outside of the screen beforehand, by measuring the current of the reference pixel which is unused for the display and controlled to be illuminated all the time during the display is in use.

Next, when the switch 21 is switched to a pixel current data storing section 23, pixels in the screen are illuminated one by one and current values of respective pixels measured by the current measuring section 5 is stored in the pixel current data storing section 23.

It should be noted that when current data measured by the current measuring section 5 is output as digital data by being converted by an analog to digital (AD) converter, the reference current data storing section 22 and the pixel current data storing section 23 are structured by registers, while when the current data is detected as analog voltage value, the reference current data storing section 22 and the pixel current data storing section 23 are structured by storage capacitors or the like.

Then, the reference current data and the pixel current data are compared at a comparator 24. For example, one bit data is output as “1” when the pixel current data is larger than the reference current data, while the one bit data is output as “0” (or the other way around) when the pixel current data is smaller. This one bit data is stored into the frame memory 2 via the input processor 1 to be reflected for the display at an equalization process period.

The equalization process is performed by updating the one bit data in the frame memory 2 by repeating such process, for example, at every one or two hours while the display device is not in use.

### Structure for Performing A/D Conversion

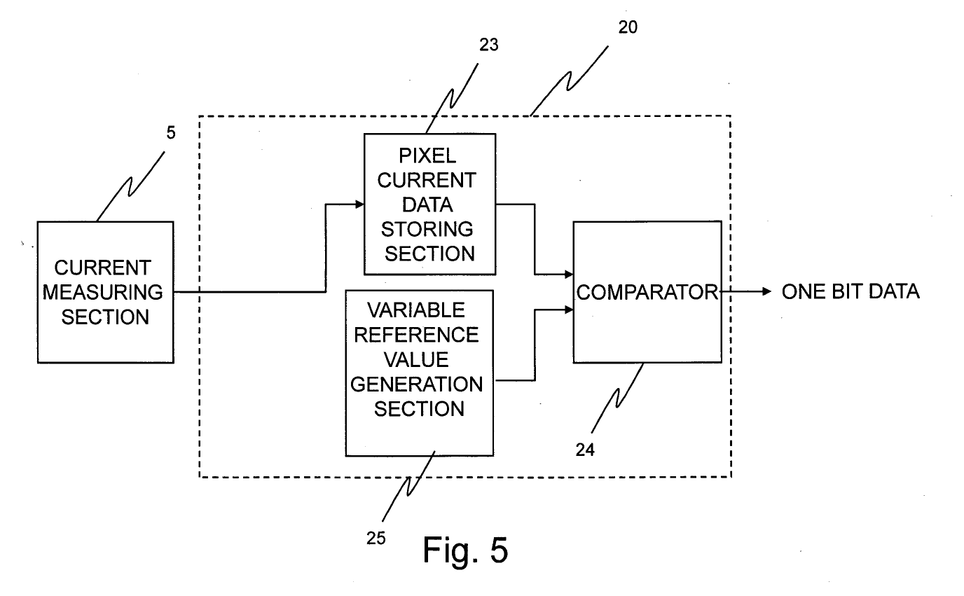

Even when no A/D converter is provided at the current measuring section 5, the measured current degree can be converted to a digital value, in other words, A/D converted by inputting signal from a variable reference value generating section 25 into an input of the comparator 24 as shown in FIG. 5.

For example, when a signal indicating current data I0 is input into the comparator 24 from the variable reference value generating section 25 and, as a result of the comparison with the pixel current data Ia, Ia>I0, “1” is output. Next, a signal indicating current data I1 is input into the comparator 24. When, as a result of the comparison, Ia<I1 and “0” is output, 2 bit data of “01” is obtained from both of the outputs, indicating that the pixel current data is between I0 and I1.

By storing the multiple bit data obtained in such a manner into the frame memory 2, current value used for the equalization process may be determined based on the data.

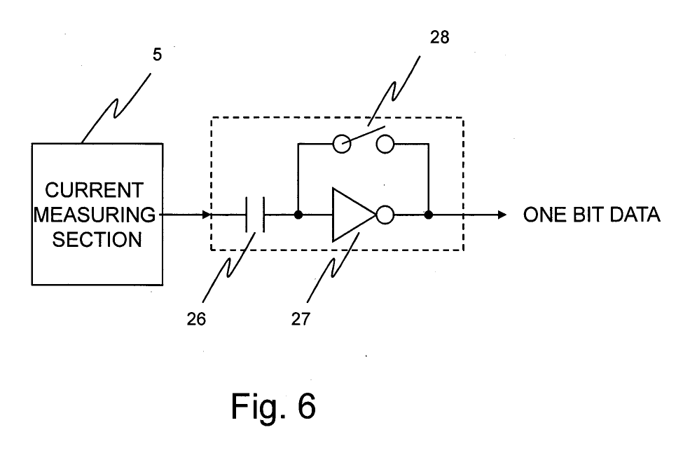

FIG. 6 shows in more detail an exemplary embodiment providing the function as described. The current values can be compared by a simple switched capacitor circuit including the storage capacitor 26 and the inverter (comparator) 27, and the switch 28 shown in FIG. 6.

At the time of storing of the reference current signal, the switch 28 is turned on to short circuit an input and an output of the inverter 27, while one end of the storage capacitor 26 connected to the input of the inverter 27 is set at an intermediate level between high and low of the inverter output. At the same time, the reference current data is supplied to the other end of the storage capacitor 26 from the current measuring section 5. This enables writing data into the storage capacitor 26 such that, when the reference current signal is input into the storage capacitor 26, the output from the inverter 27 becomes the intermediate level. Subsequently, the switch 28 is turned off and the pixel current signal is input from the current measuring section 5. When the pixel current signal is lower than the reference current signal, input of the inverter 27 shifts to low side to make the output high, while when the pixel current signal is higher, low is output. Current comparison is performed in such a manner.

Because the switched capacitor type comparator shown in FIG. 6 is a dynamic circuit, the period to retain, at a correct value, the reference current signal which is generated by the current measuring section 5 by illuminating a certain pixel to be used as a reference is shortened. Therefore, to compare current signals of respective pixels, it is preferable to compare by measuring the same pixel as a reference pixel for every comparison.

Similarly as in FIG. 5, by reflecting the comparison result to a bit string by inputting some variable reference current signals instead of reference current signals, A/D conversion similar to the above can be performed. Because the switched capacitor type comparator as shown in FIG. 6 can be structured with a simple circuit, such comparator can be formed on a substrate on which pixels are formed. This structure is beneficial for realizing a low cost.

Alternatively, in the structure shown in FIG. 5, only one reference value may be generated at the variable reference value generation section 25. As shown in FIG. 4, with such structure, a measured current may be output as analog voltage value at the current measuring section 5 to output one bit signal indicating whether the voltage value is over the reference value. As such a circuit, the switched capacitor type comparator shown in FIG. 6 may be used.

The invention has been described in detail with particular reference to certain preferred embodiments thereof, but it will be understood that variations and modifications can be effected within the spirit and scope of the invention.

### PARTS LIST

1 input processor
2 frame memory
3 output processor
4 EL panel
5 current measuring section
6 gate driver
7 pixels
8 elements
9 drive transistor
10 gate transistor
11 storage capacitor
12 data line
13 gate line
14 power line
15 cathode electrodes
20 supply controller
21 switch
22 reference current data storing section
23 pixel current data storing section
24 comparator
25 variable reference value generating section
26 storage capacitor
27 inverter
28 switch

1. A display device comprising a self-emissive type display element in each pixel, the display device further comprising:
a detection circuit for detecting light emission data which indicates an amount of light emission while sequentially illuminating only a particular one of pixels according to a particular luminance data; and
a supply controller for determining an amount of light emission for an equalization process for each pixel according to the detection result by the detection circuit and for supplying light emission data to each pixel for enabling illumination at the determined amount of light emission.

2. The display device according to claim 1, wherein the detection circuit detects, as the light emission data of the particular pixel, an amount of current in the display device while the particular pixel is emitting light.

3. The display device according to claim 1, wherein the supply controller performs the equalization process by determining luminance data for equalization based on the light emission data detected by the detection circuit, and by supplying, to each pixel, the luminance data for equalization instead of normal luminance data for each pixel.

4. The display device according to claim 1, wherein:
when displaying each pixel according to image data supplied from outside, by means of analog driving, luminance data according to the image data of each pixel is supplied to the pixel and gradation of light emission luminance of each pixel is controlled; and
when detecting the light emission data by means of the detection circuit, an amount of light emission is detected while supplying the luminance data which is constant and can be used to detect deterioration of an emissive element.

5. The display device according to claim 1, wherein:
when displaying each pixel according to image data supplied from outside, by means of digital driving, data for a controlling light emission period according to the image data of each pixel is supplied to the pixel and gradation of light emission luminance of each pixel is controlled; and
when detecting the light emission data by means of the detection circuit, the amount of light emission is detected at a time of illumination using the digital driving while supplying the data for controlling light emission period which is constant and can be used to detect deterioration of an emissive element.

6. The display device according to claim 1, wherein the self-emissive type display element is an organic EL element.

7. The display device according to claim 6, wherein, for detecting a light emission data by means of a detection circuit, the light emission data is detected by measuring a current while applying a constant voltage to the organic EL element.

8. The display device according to claim 1, wherein the light emission data indicating an amount of light emission is one bit data which is obtained by comparing with a predetermined reference value.

9. The display device according to claim 1, wherein the detection circuit detects an amount of analog current at the display device in which the particular pixel is emitting light and A/D converts the detected value to obtain digital light emission data of the pixel.

10. The display device according to claim 9, wherein the detection circuit obtains digital light emission data of multiple bits by sequentially comparing the detected amount of analog current with a variable reference value.
